(19) United States
(12) Patent Application Publication
(10) Pub. No.: US 2004/0117286 A1
(43) Pub. Date: Jun. 17, 2004

(54) PROCESS TO THE AUDIT THE PERFORMANCE OF INVESTMENT PORTFOLIOS

(75) Inventor: James Allen Charnley JR., Barrington, RI (US)

Correspondence Address: BARLOW, JOSEPHS & HOLMES, LTD., 101 DYER STREET, 5TH FLOOR, PROVIDENCE, RI, 02903, US

(73) Assignee: WATER STREET ADVISERS, INC., Barrington, RI (US)

(21) Appl. No.: 10/605,293

(22) Filed: Sep. 19, 2003

Related U.S. Application Data
(60) Provisional application No. 60/412,188, filed on Sep. 23, 2002.

(51) Int. Cl. G06F 17/60

(52) U.S. Cl. 705/36

(57) ABSTRACT

The present invention is a process to audit the performance of investment professionals in carrying out the responsibilities involved in managing the investment performance of an investment portfolio. It is unique from existing processes to evaluate investment manager performance in that its evaluative methodologies conform to the minimum standards of required of an audit process in that the evaluative findings are complete, unbiased and consistent over time. The findings derived from the method are complete because it includes the review of four specific selection functions critical for sustaining relative portfolio performance over time and generates an explicit evaluation of each of these four functions. The findings derived from the method are unbiased and consistent because they measure manager performance relative to whole-population samples of managers engaged in the same functional activities over multiple market periods. Existing systems benchmark manager performance against securities-market indices or narrow samples of investment manager populations, which have been shown in use to generate biased and inconsistent measurements as market conditions change. This capability to produce an evaluation of investment manager performance of audit quality arises from the insight that functions involved in selecting an investment portfolio can only be evaluated from the perspective of benchmarks generated from complete populations of alternative selection strategies if such an evaluation is to be complete, unbiased and consistent over time.

### CROSS REFERENCE TO RELATED APPLICATIONS

This application claims the benefit of U.S. Provisional Application Serial No. 60/412,188, filed Sep. 23, 2002.

### BACKGROUND OF INVENTION

This is a process of the present invention relates to auditing the performance of investment portfolios. Its business use is anticipated to be an audit of those individuals whose responsibilities are for the performance of investment portfolios investment managers. It is unique from existing processes to evaluate investment managers in that its evaluative methodologies conform to the standards required of an audit process.

These standards entail the requirement that an audit's measurement of a functional activity be 1) complete; 2) unbiased and 3) consistent over time and changes in market conditions. The proof of the uniqueness of this process lies in the demonstration that it includes these qualities and that existing evaluative processes fall short in one or more of these requirements.

This audit process uses a series of evaluative processes that are unique and novel in their own right. Their uniqueness comes from finding patterns in the relative performance of managers in the discharge of their investment management functions that have not been identified by existing methodologies. Their distinction from these previous methods is that they identify these patterns of relative performance using measurement standards that are novel in their qualities of providing unbiased and consistent benchmarks of relative performance over varying market conditions. This audit process inherits its qualities of fairness and consistency from these evaluative processes.

This combination of these functional processes provides the necessary procedural steps to ensure completeness of the audit process. It is convention to measure manager performance in terms of their portfolio's investment performance. Investment performance is the tradeoff between a portfolio's investment returns and the risks associated with those returns. Earlier in the twentieth century it was common for economists to denominate investment risk in terms of the risks of both investment loss and investment uncertainty a distinction that to this point has been missing from evaluative processes developed to date.

The distinction between the risks of investment loss and investment uncertainty is a concept first published by Dr. Frank Knight in his thesis, Risk, Uncertainty and Profit (1921). Knight used this distinction to account for the discontinuance he had found between the rate of return for capital investment as anticipated by economic theories and the rate of return he found existed in the real world. He explained the excess return found in empirical evidence as a product of compensation to investors for uncertainty risk. [Backhouse, p.202-204]

John Maynard Keynes later picked up this distinction and used it in his work, General Theory of Employment, Interest and Money (1936). Keynes postulated a direct relationship between investment and uncertainty, arguing that investors” actions depended not of a rational calculation of future returns, but on their confidence in the face of investment uncertainty. [Backhouse,

p.230].

Processes to generate a quantitative evaluation of the performance of investment portfolios and investment managers are younger than this distinction having been developed since the introduction of the first mathematical models for quantifying investor behavior by Dr. Paul Markowitz in his treatise, Modern Portfolio Theory [Markowitz, 1956]. In his models, Dr. Markowitz identified investment risk as specifically related to the risk of investment loss—perhaps because it was the risk benchmark for which he could easily generate a statistic given the paucity of empirical data at the time. The result of this is that the focus of both the academic studies and industry applications that have followed this work over the last fifty years has been limited to this narrower definition of investment risk.

Of the two types of risk, the primary reason investors create investment portfolios and hire investment managers is to control investment uncertainty. The omission of the measurement of this risk is a key shortfall in existing evaluative systems. The innovation of this audit process is that it corrects for this deficiency. In doing so, it becomes uniquely qualified as an audit process in terms of its completeness.

Prior Art

The record of patent art is a short list because of the newness of the business process option. Thus said, a review of prior art must include past industry and academic studies as well. The list of these studies extends back to the introduction of Modern Portfolio Theory in 1956.

Although avoided by economists as an explicit subject for their studies of investment managers, investment uncertainty is a phenomenon that has repeatedly injected itself into the findings of those studies. Investment uncertainty is the risk that market conditions will change that the historical record of investment relationships will be altered by an unanticipated market event. The history of the academic literature regarding the dynamics of investment manager performance is a record full of attempts to find patterns of differences in the past performance of these managers that will signal future performance differences models using the arts of prediction and representing the holy grail of investment-market economics. Investment uncertainty, as an “externality”, has been the bane of these attempts, constantly confounded researchers in their search for this predictive capability.

As example, at the functional level of investment selection, there have been a series of such studies conducted over the last fifty years, the first of these studies asserting that persistent differences in manager performance could not exist—[Jensen, 1968], [Grant, 1978], [Malkiel, 1995], [Sharpe, 1996]—while a later set of studies found that differences could in fact persistence, albeit for only short periods of time and under special market conditions—[Grinblatt, 1992], [Hendricks, 1993], [Goetzmann, 1994], [Brown, 1995], [Wermers, 1996], [Cahart, 1997].

The structure of these studies has been to group investment managers within an asset class on the basis of differences in investment performance over a short period of time—5 to 10 years and then calculate the average difference in investment performance between these groups over a subsequent and equally short period of time. Market conditions can change and have historically done so on a regular basis with much the same general periodicity as these studies. Since the risk of investment uncertainty is defined in terms of unanticipated changes in future market conditions, the conundrum generated by this body of prior work is emblematic of the cause and effect of investment uncertainty on a body of seemingly naïve academic studies.

With the recognition of the phenomenon of investment uncertainty, one could surmise that the record of disparate findings for studies of performance persistence among investment managers is a confirmation of that phenomenon and a demonstration of its effects among a population of academicians whom have chosen not to anticipate it. In that regard it is interesting to note that the special market condition cited by those studies finding for intermittent and short-lived persistency is that “market conditions do not change”.

Problem to be Solved

The conundrum created by these academic studies has been heightened by their analytical focus. As cited above, the analysis of differences in manager performance has historically been a search for “the holy-grail” an effort to identify a process of predictive selection that would consistently signal which investment managers would be “the winners” of a future period. Mutual funds are a type of investment portfolio that is managed by an investment manager. Because mutual funds offer shares of their portfolios to the general public, statistics of their investment performance are published on a consistent and regulated basis. The ready availability of this standardized performance data has prompted academicians to study differences in investment portfolio performance through the history of differences in performance among the population of mutual funds. Processes of predictive selection have been based on the concept that the successful track record of fund managers in a past period should persist—that “winners repeat”. Thus said, the segmentation strategies employed in grouping populations of fund managers have revolved around dividing an asset-class population between its strongest and weakest members in terms past-period investment performance and looking for a pattern of persistent differences in investment performance from these segments into the future.

The convention of ranking populations of managers or other investment alternatives in terms of their past strength of investment performance is a method of differentiation that relies solely on the consideration of investment-loss risk. Investment-loss risk is the contingency that sometime over an investment period, an investment alternative will produce a loss of a magnitude that its investment-period average return will be impinged by that loss. A worst-case scenario is that the magnitude of the loss is so great as to cause the period return to drop below zero that there will occur an investment-period loss of invested capital. Loss risk is calculated from the same basis as investment performance it is the tradeoff between the variance of returns and their average. Thus, attempts to identify the managers within a population that have had the best investment performance is the same as identifying those managers that put their portfolios in the least loss-risk for that investment period.

The response of academicians frustrated with their lack of success in finding performance persistency has been to focus on more exacting models of differences in investment performance between investment managers looking for finer divisions or additional dimensions of the performance measurement that can be applied to the problem to identifying the key indicator of future winners. The history of academic research is the tale of searching for better tools with which to differentiate between investment alternatives in regards to investment-loss risk.

The success that academicians have had in developing these tools has not been heartening. The general consensus emerging from these efforts is that these tools may be impossible to fashion because there may not actually exist a pattern to differences in investment manager performance. Of late, the hypotheses put forth by research economists appear be an abandonment of their efforts to find a pattern and a concession to allowing their research to serve the purpose of discounting the value of their peers whom have gone on to become investment managers: “funds in the top percentile differ substantially each year, with more than 80 percent annual turnover in composition . . . last year's winners subsequently become next year's losers and vice versa, which is consistent with gambling behavior by mutual funds . . . the year-to-year rankings on most mutual funds appear largely random . . . The[se] results do not support the existence of skilled or informed mutual fund managers” [Cahart, 1997, p71]

The investment industry has adopted the tools crafted by these academicians “whole-cloth” as its basis for processes to evaluate the relative performance of investment portfolios and herein lies the problem. In practical application, there exists a myriad of investment strategies and investment alternatives from which to construct an investment portfolio. The attractiveness of these choices is related to their performance strength in regard to future market conditions and, as alternatives, they all can be expected to react differently to these future conditions.

The manager that is most successful in solving for the problem of loss risk the manager that attains the highest levels of investment performance for his portfolio in a current period—is the one whose selections of investment alternatives are most favored by the conditions that prevailed over the subject market period. Since market conditions change over time, these selections cannot be expected to remain favored. In fact, the closer their performance is tied to the fortunes of a current market, the least likely they are to survive as strong alternatives in a future period. This is a condition driven by the phenomenon of investment uncertainty.

In the practical world, there exists a significant cost, and thus a significant amount of inertia to changing the composition of an investment portfolio. These costs include transaction expenses, as well as tax liabilities associated with the divestiture of existing investment positions. These costs are what raise the bar for investment uncertainty. Those portfolios that have been constructed most aggressively to profit from current market conditions are the ones within a population whose profits will be most reactive to changes in those market conditions. When market conditions change, they will likely be among those portfolios least apt to profit from those changes. Continual divestitures and acquisitions to change the composition of a portfolio in response to anticipated changes in market conditions would be the prudent strategy, except that a manager has to be extraordinarily adept at and confident of his ability to anticipate those changing conditions to avoid destroying the portfolio returns through the costs of erroneous divestitures and untimely acquisitions.

In practice, there exists an operational tradeoff between the management of investment-loss risk and that of investment uncertainty. A manager can only be successful over time if he can successfully manage the balance between the two risks. An evaluation process is incomplete unless it can measure for both these conditions and the performance of a manager in balancing the control of the risk of each. If an evaluative process is incomplete in its measurement of a functional activity, it is not qualified as an audit process. The capability of this evaluative process to recognize and measure performance in regard to both investment loss and uncertainty risk the novelty that makes it an audit process.

Background Investment Portfolios and Their Management

When an investor acquires an investment, he has created an “investment portfolio”. Because of the contingency that the acquisition will turn out to be a less than an optimal choice at a point in the future (risk of investment uncertainty), it is usual for investors to “spread their risk” and hold more than one investment in portfolio. Such an investment strategy is called “diversification” and it is characteristic for investors to hold a diversified portfolio for the express purpose of controlling uncertainty risk.

It is also characteristic of investors to acquire investments whose future performance is expected to be strong acquisitions whose risk of investment loss has historically been minimal. Such an acquisition strategy relies on knowledge of past patterns of performance and the projection of those patterns into the future. This is a strategy of “prediction” based on past experience and it is also characteristic for investors to rely on predictive processes for the express purpose of controlling the risk of investment loss.

Investors have the need to evaluate how their investment portfolios are performing. Such an evaluation requires a standard measure, and the general standard within the industry for assessing the performance characteristics of a portfolio the measure of “investment performance”.

Investment performance is the tradeoff between investment return and investment risk. Investment return is calculated as the average of a series of contiguous periodic returns for example, the average of a 10-year series of annual returns equals a 10-year average return. Investment risk is calculated as the variance of these periodic returns around their average. Investment performance is the ratio of the average of periodic returns to the variance of those periodic returns.

It is a generally accepted axiom within the industry that the goal of investors is to maximize the investment performance of their portfolios. The maximization of investment performance relates to the control over the contingencies of investment loss and investment uncertainty in the following manner. Expectations of investment loss are derived from the analysis of past patterns of investment performance and their relationship to past market conditions. The probability of investment loss is a statistic that can be calculated on the same basis as investment performance—as the ratio of the average of periodic returns to the variance of periodic returns for an investment period. Expectations of investment uncertainty cannot be derived from the analysis of past patterns. The risk of investment uncertainty is minimized and investment performance is maximized—by correctly anticipating the effect of future market conditions on past patterns of investment performance and their relationship to past market conditions. In the absence of compelling evidence of future market conditions, investment uncertainty is controlled by the process of diversification.

As example, investors expect their risk of investment loss to be less for a portfolio of domestic bonds than for a portfolio of stocks, and indeed the probability of a loss for a portfolio of domestic bonds has been 60% that of a portfolio of domestic stocks on average over the series of 3-year analysis periods in the time period 1962-2002. An investor concerned with minimizing his investment risk and who anticipated that market conditions would remain the same as they have been as a historical average would control his risk of loss by investing in a portfolio of bonds rather than a portfolio of stocks.

The risk of investment uncertainty is the unexpected level of investment performance for an investment alternative that ratio of average return to returns volatility that cannot be anticipated from historical experience and that is yet to be tabulated in a future time period. Most investors did not anticipate the speculative bubble that rose in the 1990“s to create a temporal and sharp appreciation of domestic stock prices that would make their average loss risk over that ten-year period virtually equal to that of a portfolio of domestic bonds. An investor concerned with minimizing his investment risk and able to anticipate the bubble would minimize his risk of investment uncertainty be changing the composition of his portfolio to 100% stocks. An investor who could not predict the timing of such a bubble, but that was cognizant of the fact that investment markets could can contain such bubbles would control his risk of investment uncertainty by diversification—investing in a portfolio of both bonds and stocks.

As a practical matter, an investor would have to consider a balance between both these strategies. By investing 100% in bonds the investor gives up the security of participating in other market sectors where the returns may be more favorable over his investment period. By investing 100% in stocks, he gives up the safety of a “proven” low-risk investment. The subsequent evaluation of his investment portfolio for its performance must take into account the management of both these risks the control over the contingencies of both investment loss and investment uncertainty and the efficiency attained by their balance. If it does not, it is not complete.

The performance of an investment portfolio is managed at (2) functional levels allocation strategy selection and investment selection. This functional distinction has arisen from limits on the ability of analysts historically to effectively synthesize the number of diversification alternatives available from combining the population of investments available across the +$40 trillion market for publicly-trade securities.

It is a first principle within the industry, derived from Modern Portfolio Theory, that asset diversification is accomplished through a process of combining investments with different and offsetting investment risk. The generally accepted practice for identifying the optimal combination of portfolio assets is to solve for an equation that simultaneously analyzes the relationship between the historical patterns of periodic-return variance of pairs of investments within the portfolio (the covariance of their investment risk). This equation can become unwieldy for a strategy that considers a large number of available investments the pair-wise comparison of (1,000) alternative investments, for example, entails an equation with approximately 500 thousand covariance terms.

Thus said, it is common practice to segment the population of available portfolio investments into a “small handful” of market sectors groupings of investments whose past pattern of investment risk has been uniquely similar—and to solve for an “asset allocation strategy” in terms of the optimal relationship between these market sectors. In this context, the investments within each market sector are considered an “asset class” and the performance characteristics of that class are represented either by a sample of the investments (an “index”) or an average calculated for all investments within the class.

Selecting for an asset allocation strategy in terms of asset-class distributions is the first functional level of portfolio management. Once the strategy has been determined, the next function is to select for a specific investment from among the population available within each class with which to implement the strategy. Because of the aforementioned contingency of and investment uncertainty, it is common practice to select for a diverse set of investments from each class.

Once an investment portfolio is acquired, it has no value beyond that of the net value of its assets its book value. In that regard, an investment portfolio performs differently over time than that of primary-market securities such as stocks or bonds whose values are determined by investor demand market-valued investments. This is a distinction that one will not find in the record of academic literature or patent art related to investment selection and evaluation processes and is the key insight that makes the my processes unique from prior art.

Because of this difference in valuation basis, populations of investment portfolios operate differently than populations of primary-market securities. Benchmarks created to measure the relative performance of populations of primary-securities will not necessarily apply to populations of investment portfolios. In fact, using empirical data from the last forty years, it can be demonstrated that applying benchmarking and evaluative processes originally created for the primary-securities markets to populations of investment portfolios will produce systematically erroneous results that have little or no utility in providing a relative measure of an investment portfolio's performance.

An evaluative process, to be considered of audit quality must be built upon a system of measurements that are unbiased and that provide a benchmark measure that remains consistent over time and changes in market conditions. This audit process relies on several pre-existing processes that are currently subject to approval as patent applications to create this system of unbiased and consistent benchmarks.

The central premise of these pre-existing processes is that prevailing industry practices to measure relative performance for populations of book-valued investment alternatives are flawed, and that by correcting for these flaws one can create a process that will identify differences in future performance among the members of these book-valued populations that are both economically and statistically significant.

In practice, these existing processes rely on measurement systems that have been constructed to generate indications of past-period differences in the performance characteristics between members of a book-valued population that are, by definition, unbiased. This comes about by a procedure to use “whole-populations” of these book-valued assets as the analysis sample, and to construct benchmarks of performance that are confined to these whole-population samples.

These processes are also constructed to develop their statistical evidence in the context of temporal consistency, using measurement criteria that are constructed to be neutral to changes in market conditions. This attribute of temporal consistency can be tested because the use of whole-population samples allows for the comparative analysis of the measurement criteria against a constant sample over multiple time periods. This neutrality results from a system of benchmark measures that are derived “internally”—ones reliant only on the performance characteristics of the subject population of book-valued assets.

### SUMMARY OF INVENTION

The present invention preserves the advantages of prior art methods for auditing the performance of investment portfolios. In addition, it provides new advantages not found in currently available processes and overcomes many disadvantages of such currently available processes.

Investors rely on investment professionals to either manage or advise them on the management of their investment portfolios. There are a number of ancillary functions that can be filled by these professionals tax and financial planning, etc. However, the primary responsibility of managing an investment portfolio is that of selecting the investments that populate that portfolio.

This invention is a process to audit the performance of investment professionals in carrying out this responsibility. It is a responsibility that is discharged as (4) specific selection functions, and this process is unique among audit systems in that it generates an explicit evaluation of all of these four functions. This capability arises from the insight that functions involved in selecting an investment portfolio can only be evaluated from the perspective of benchmarks generated from complete populations of alternative selection strategies if such an evaluation is to be complete, unbiased and consistent over time. Such complete-population benchmarks for three of the four functions to be analyzed have not previously existed, and this invention makes use of two processes currently in pending patent applications, also invented by Applicant, to generate the necessary benchmarks.

An audit system, to be functional, must possess these three attributes completeness, fairness and consistency. My invention will be useful because it will be the only process available for the audit of the performance of investment portfolios that possesses these three characteristics.

### BRIEF DESCRIPTION OF DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a prior art mean-variance graph where point A denotes investment performance as the intersection of investment return and investment risk;

FIG. 2 is a prior art mean-variance graph illustrating comparative investment performance where the differences in the relative strength of performance among various investment alternatives can be compared in terms of differences in investment return and risk;

FIG. 3 is a prior art mean-variance graph illustrating comparative investment performance relative to a market line as constructed under the tenets of the Capital Asset Pricing Model;

FIG. 4A is a prior art mean-variance graph illustrating comparative investment performance for a population of investment managers selecting for asset allocation strategies relative to the benchmark of a “market portfolio”, identified as the point of tangency between an efficiency-line population constructed under the tenets of Modern Portfolio Theory and a market line;

FIG. 4B is a prior art mean-variance graph illustrating comparative investment performance of a population of investment managers selecting for investments within an asset class, relative to a market line constructed using the average investment performance for the class;

FIG. 5A is a mean-variance graph illustrating the characteristic relationship between the point of average investment performance for investment managers engaged in selecting for asset class investments and a benchmark of a “population portfolio”(“pop avg”), constructed as the performance of a portfolio made from all investment manager selections within the asset class, as proposed in the pending patent application, “Process to Create Market-Sector Investment Portfolio Performance Indices”, Ser. No. 10/60,471;

FIG. 5B is a mean-variance graph illustrating the method of the present invention for evaluating investment manager performance by segmenting a population of investment managers engaged in selecting asset class investments into (4) groups possessing uniquely similar characteristics of investment loss and investment uncertainty risks by dividing the class population at the point of returns variance for the population portfolio (“risk-axis”) and the asset class market line;

FIG. 6A is a mean-variance graph illustrating the characteristic relationship between the point of average investment performance for investment managers engaged in selecting for asset allocation strategies (“average”), a market line drawn through this point of average for a population of allocation alternatives and a benchmark of a “population portfolio”(“pop avg”), constructed as the performance of a portfolio made from all investment manager selections for allocation strategies, as proposed in the pending patent application, “Process for the Selection and Evaluation of Investment Portfolio Asset Allocation Strategies”, Ser. No. 10/604,699;

FIG. 6B is a mean-variance graph illustrating the method of the present invention for evaluating investment manager performance by segmenting a population of investment managers engaged in selecting asset allocation strategies into (4) groups possessing uniquely similar characteristics of investment loss and investment uncertainty risks by dividing the allocation alternative population at the point of returns variance for the population portfolio (“risk-axis”) and a market line drawn through the point of average performance for the population;

FIG. 7 is a table for associating the stated investment objectives of investment managers and market categorization of investments with market sector designations for the purpose of identifying a selected asset allocation strategy from a list of investments held in an investment portfolio;

FIG. 8 is a flow chart illustrating the steps of the method of the present invention;

FIG. 9 is a chart of the descriptions of the allocation strategy evaluation, market-sector diversification and investment evaluation output modules in accordance with the present invention; and

FIG. 10 is a chart of the descriptions of the input modules for identifying the selected allocation strategy and selected asset class investments for an investment portfolio made up of mutual funds and primary securities.

### DETAILED DESCRIPTION

The invention uses a series of benchmark measures to model for the results of investment portfolio performance that are created under the scenario of complete diversification. These benchmark measures arise from unique processes that are the subject of separate co-invented patent applications (“Process for the Selection and Evaluation of Investment Portfolio Asset Allocation Strategies”, Ser. No. 10/604,699 and “Process to Create Market-Sector Investment Portfolio Performance Indices”, Ser. No. 10/604711).

These benchmarks are constructed from databases of investment performance data for an entire population of mutual funds existent within each monthly period since January 1960. They do not necessarily need to be constructed from a population of mutual funds. Populations of other book-valued investment funds can be substituted separate accounts, privately held investment portfolios, unit investment trusts and other types of book-valued collectively or privately held investment funds common in other country jurisdictions are examples of alternative populations with which to build these databases.

For certain auditing applications sub-groups of this mutual fund population can also be substituted. For example, the analysis of the performance of portfolios held in conjunction with 401(k) and other employee benefit programs entails the assessment of investment alternatives that have historically carried much higher management expenses than the average expenses charged against the gross returns of other classes of funds or a privately held investment portfolio. This is because the funds used in 401(k) programs are structured to absorb a host of administrative and sales expense not found in other applications. It assessing the prediction and diversification strengths of such portfolios, it would be prudent to compare them with a limited population of mutual funds that are marketed specifically for this market.

The common feature of the population groups and the performance benchmarks made from these populations is that they include managers whose portfolios are valued at book-value, as opposed to market-value. The performance of market valued shares of a collective investment fund or other market-valued investment portfolio reflect investor demand for those shares, in addition to the value that arises from the performance of their investment manager. Populations of these portfolios are not suitable for a system to audit investment portfolio manager performance. Examples of these entities are exchange-traded funds and closed end investment companies (closed-end funds).

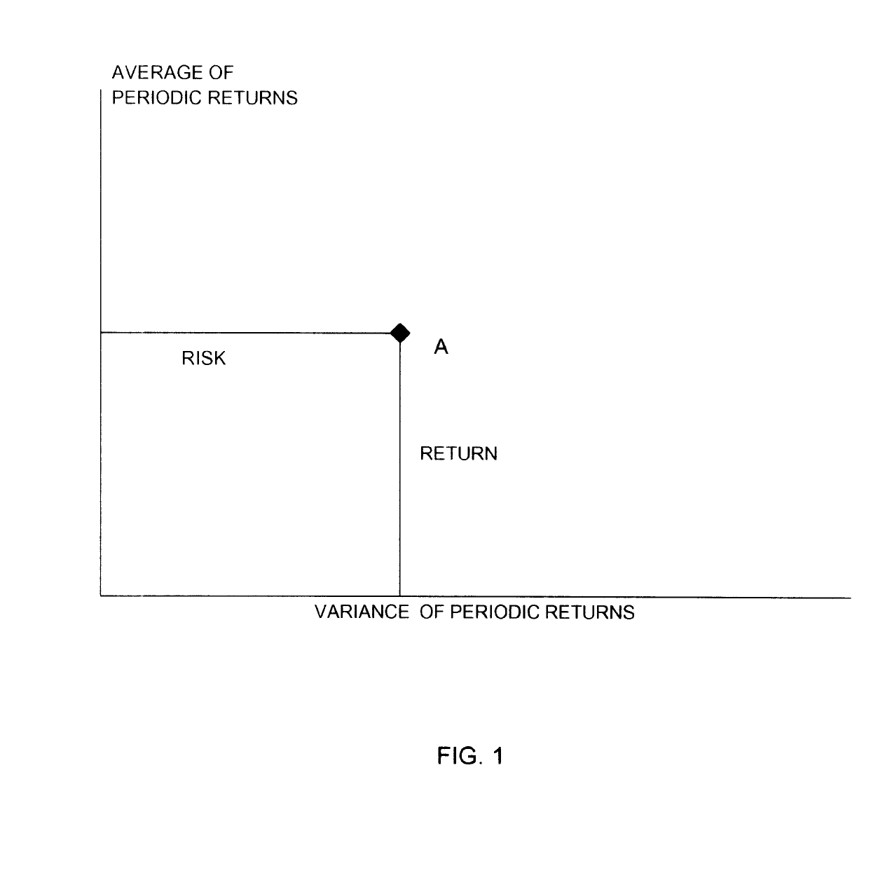

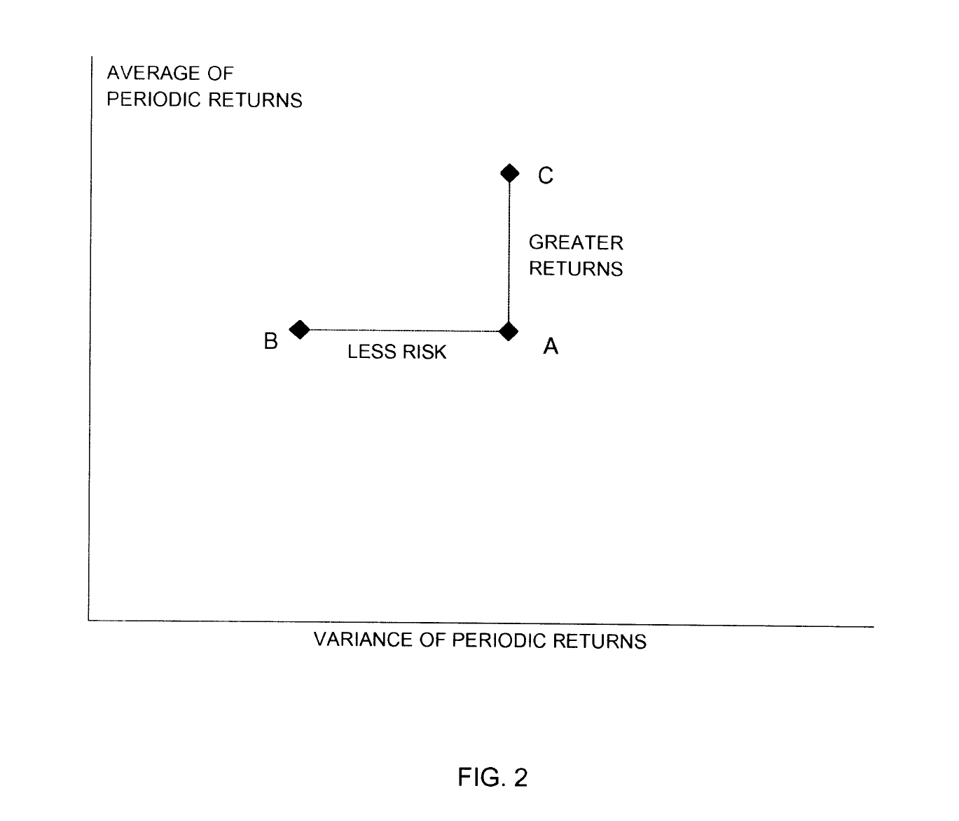

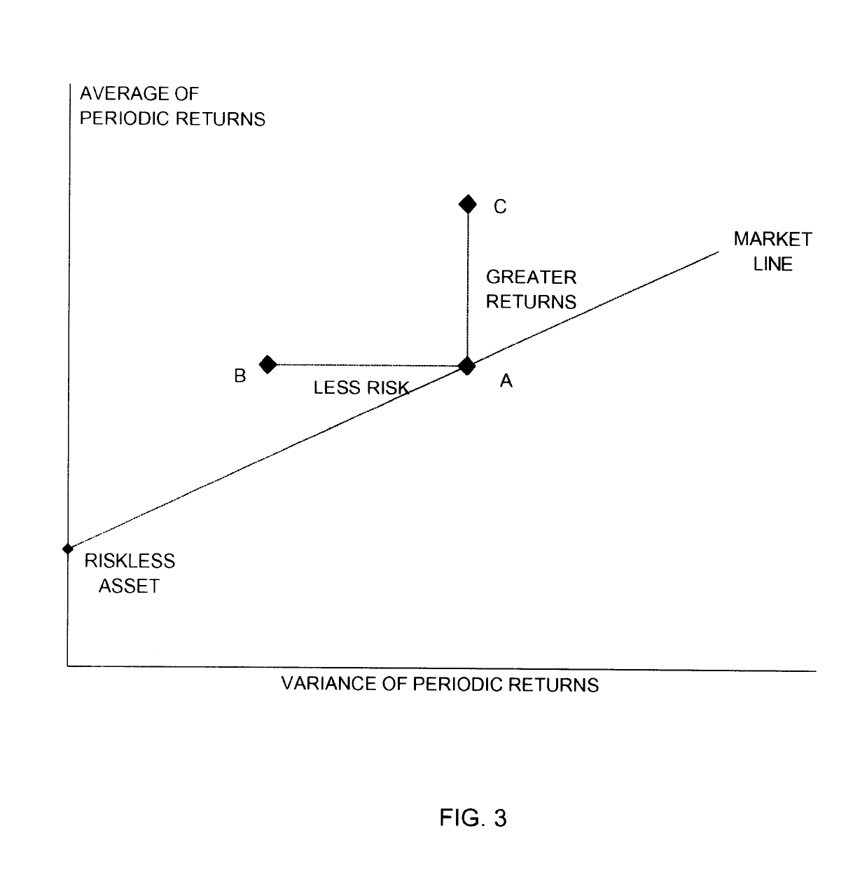

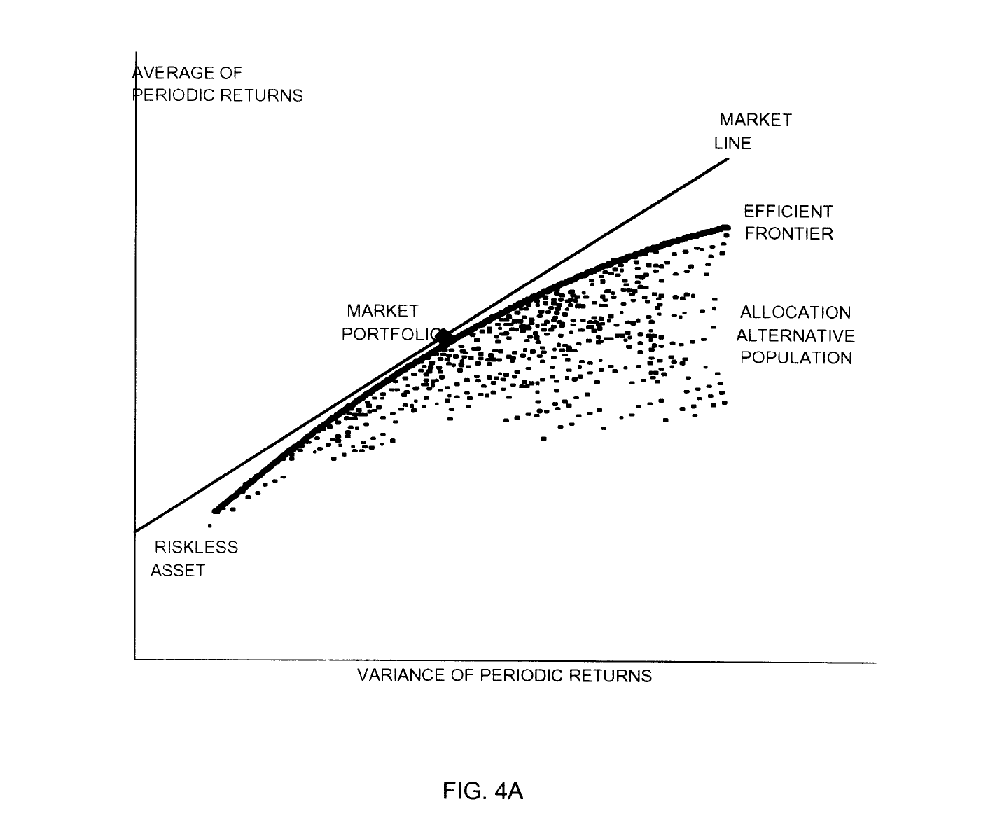

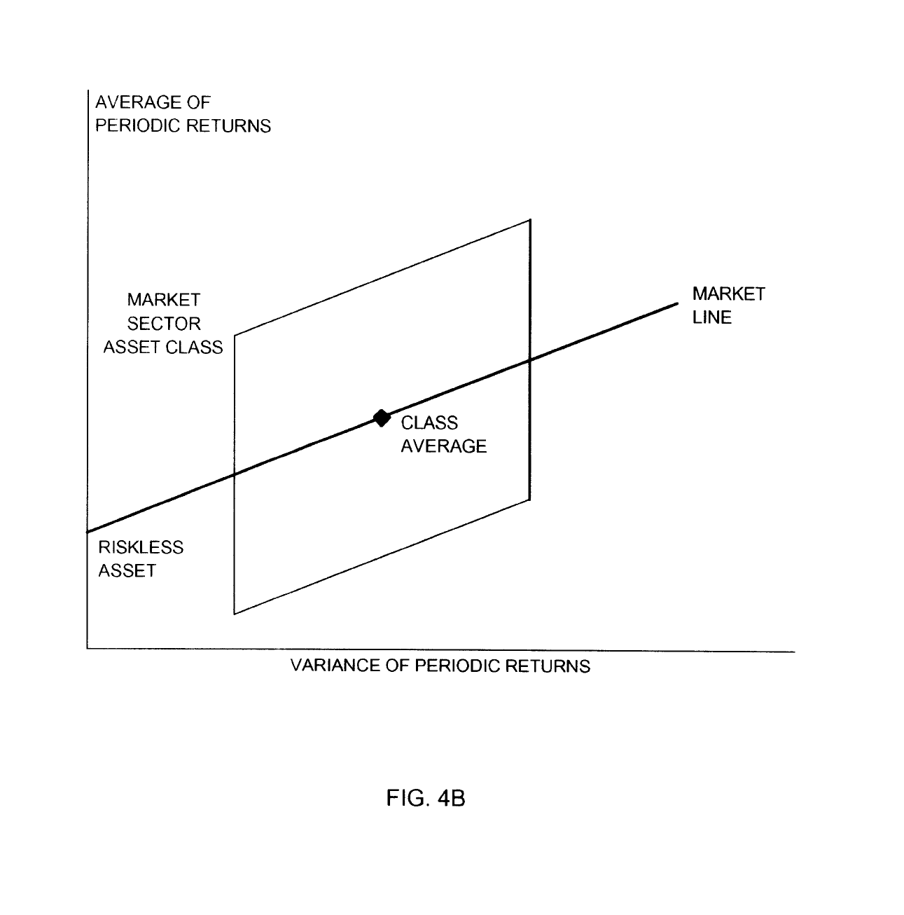

This process audits for performance standards that are uniquely comprehensive of an evaluation of the responsibilities of an investment manager to select investments for an investment portfolio. It includes an evaluation of the diversification processes, as well as, the predictive processes involved in discharging this responsibility. FIGS. 1, 2, 3, 4A and 4B illustrate known concepts of risk and return and the evaluation of investment loss risk for the functions of allocation strategy and investment selection. These existing evaluative procedures are incomplete in that by measuring only for differences in loss risk in a current period they calculate only for the relative success of the predictive processes used in portfolio management. A complete audit of the management function would also include differences in performance for the management of the risk of investment uncertainty by measuring for the relative success of the diversification processes by investment managers.

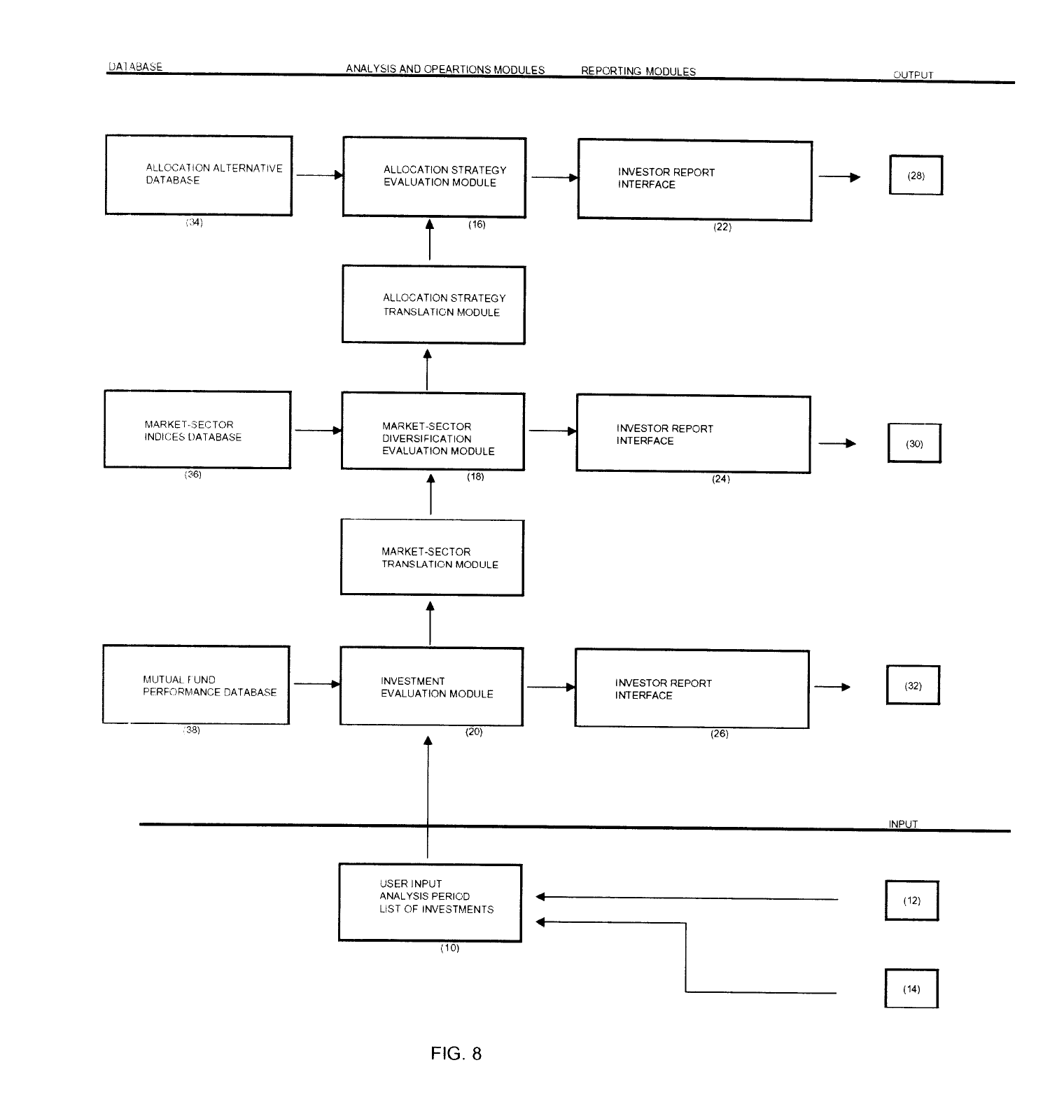

As shown in FIGS. 8-10, the audit process is comprised of nine modules—module 10 to accept user input regarding the composition of an investment portfolio, two modules 12 and 14 to translate that input into higher aggregations of portfolio composition and management functions, three modules 16, 18 and 20 to analyze the performance of the portfolio in terms of these aggregate levels of management and three modules 22, 24 and 26 to communicate these findings to the user.

The management of an investment portfolio involves the management of two types of risks investment loss and investment uncertainty performed at two functional levels asset allocation strategy and investment selection. Of the three analysis and reporting modules 16, 18 and 20 of this audit process, module 20 reports the findings of manager performance for the management of investment loss risk in their action of investment selection at the market-sector selection level, module 18 reports the findings of manager performance for the management of both investment loss and investment uncertainty risk in their action of investment diversification at the market-sector selection level, and module 16 reports the findings of manager performance for the management of both investment loss and investment uncertainty risk in their action of asset allocation alternative strategy selection.

The process utilizes three databases 34, 36 and 38. The first—Allocation Alternative Database 34 is derived from the separate process in the above patent application for “Process for the Selection and Evaluation of Investment Portfolio Asset Allocation Strategies”, Ser. No. 10/10/604,699 which is used to generate asset allocation strategy level benchmarks of investment loss and investment uncertainty risk for the process of strategy selection. A second database 36, the Market-Sector Indices Database, is derived from the separate process which is from the above pending application for “Process to Create Market-Sector Investment Portfolio Performance Indices”, Ser. No. 10/604,711 which is used to generate market-sector level benchmarks of investment loss and investment uncertainty risk for the process of investment selection. A third database 38, a Mutual Fund Performance Database, is purchased from an outside provider and used to generate benchmarks of investment loss risk for the predictive process of individual investment selection.

These performance benchmarks are used in the three analysis and reporting modules, the Allocation Strategy Evaluation Module 16, Market-Sector Diversification Evaluation Module 18 and Investment Evaluation Module 20. These modules compare the performance of an investment portfolio over various timeframes with population averages made from its peers at the functional levels of investment management of a portfolio and in terms of predictive and diversification processes employed at these levels.

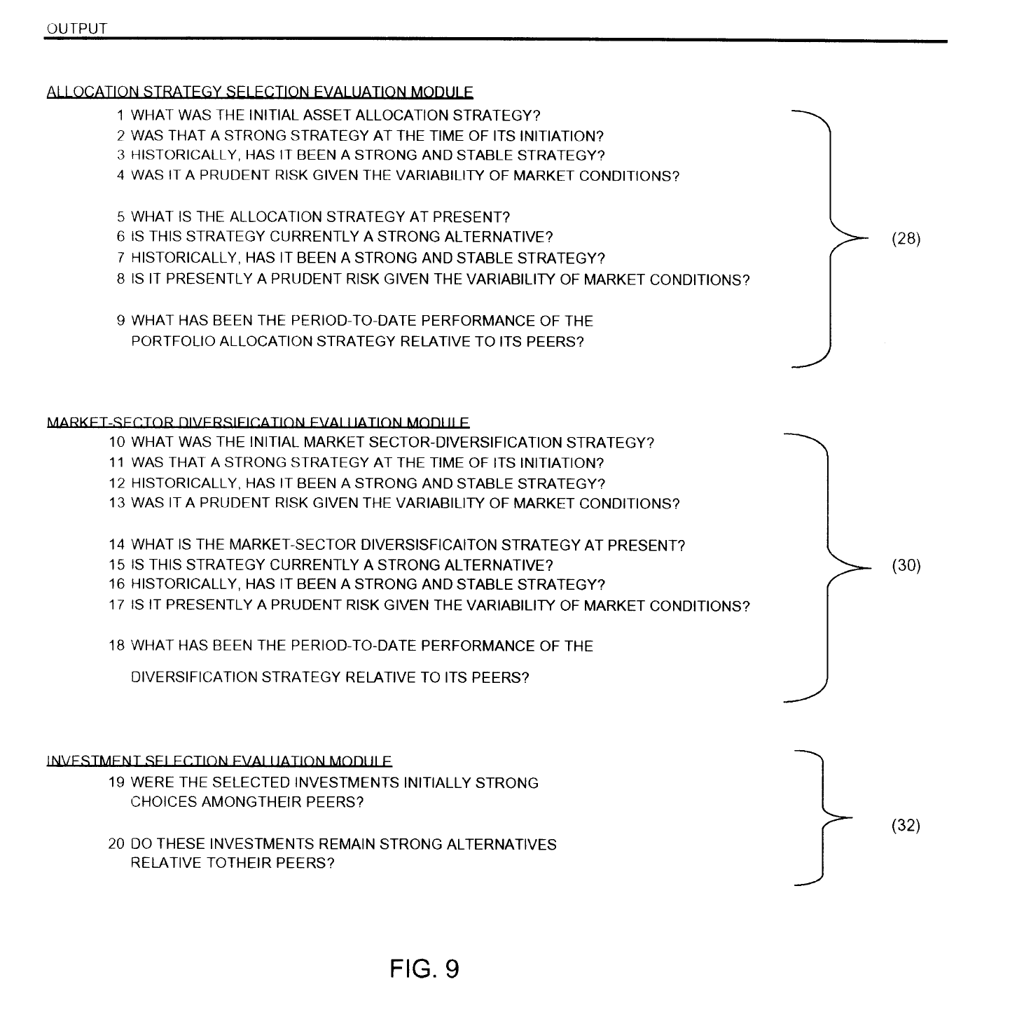

The user receives a report of findings an “Audit Report” that is generated at the results tabulated in the analysis performed within the three analyses and reporting modules. This Report is formulated through three Interface Modules 28, 30 and 32 which are designed to provide either written or computer-based output that illustrates the conclusions of the audit in a simple and easy to grasp set of graphics. Details of these modules are shown in FIG. 9. The purpose of this graphic interface is to translate the findings into a simple and consistent set of indicators that a user not intimately familiar with the nuances of the analysis can absorb quickly and without additional research.

The evaluation provided by this Audit Report covers the following points:

The design of the invention as currently formulated also includes several detailed methodologies for the user interface:

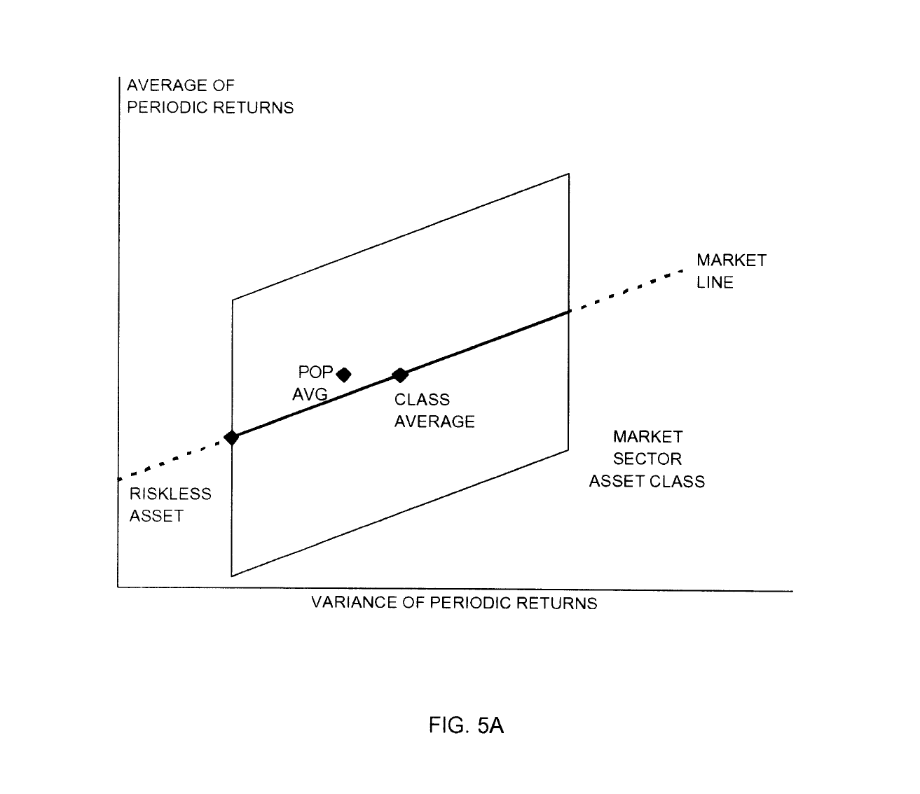

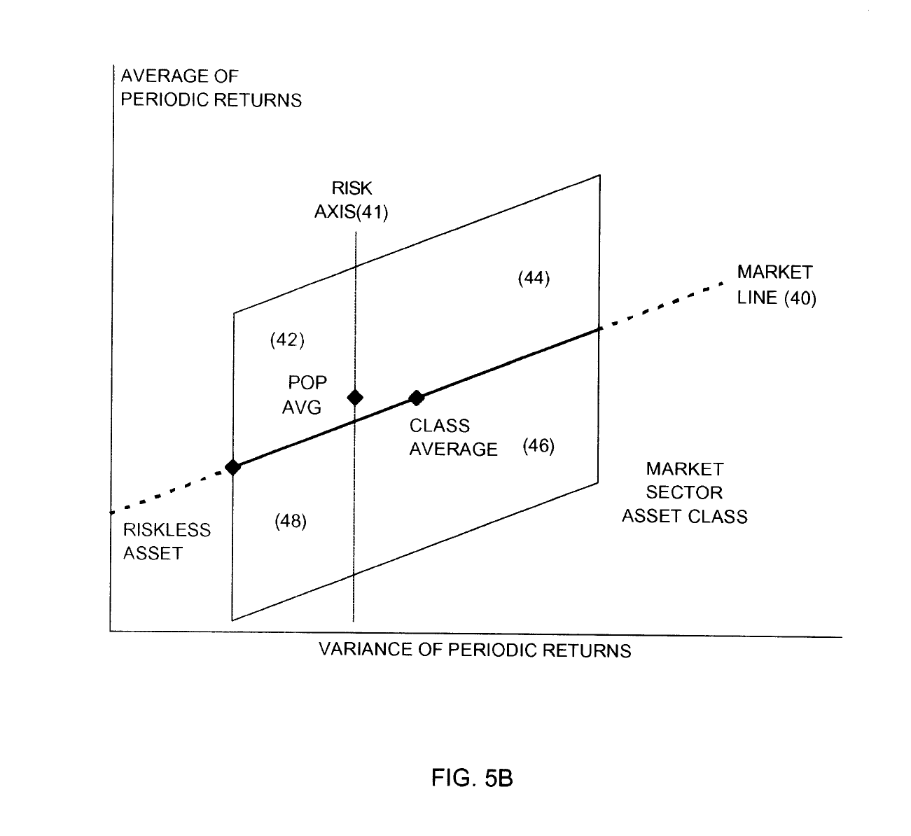

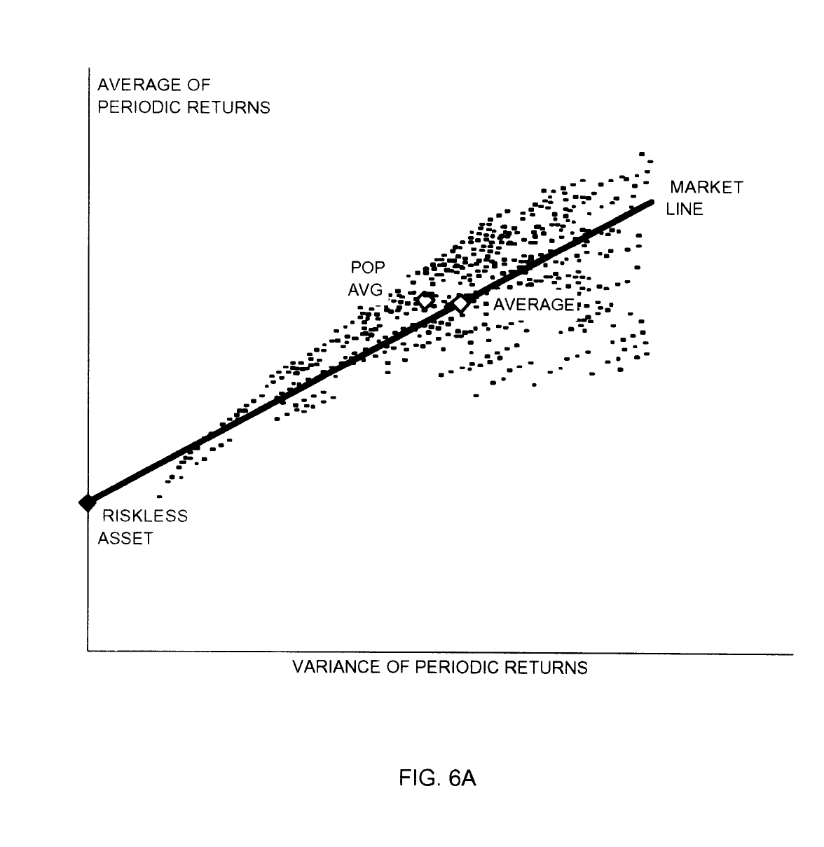

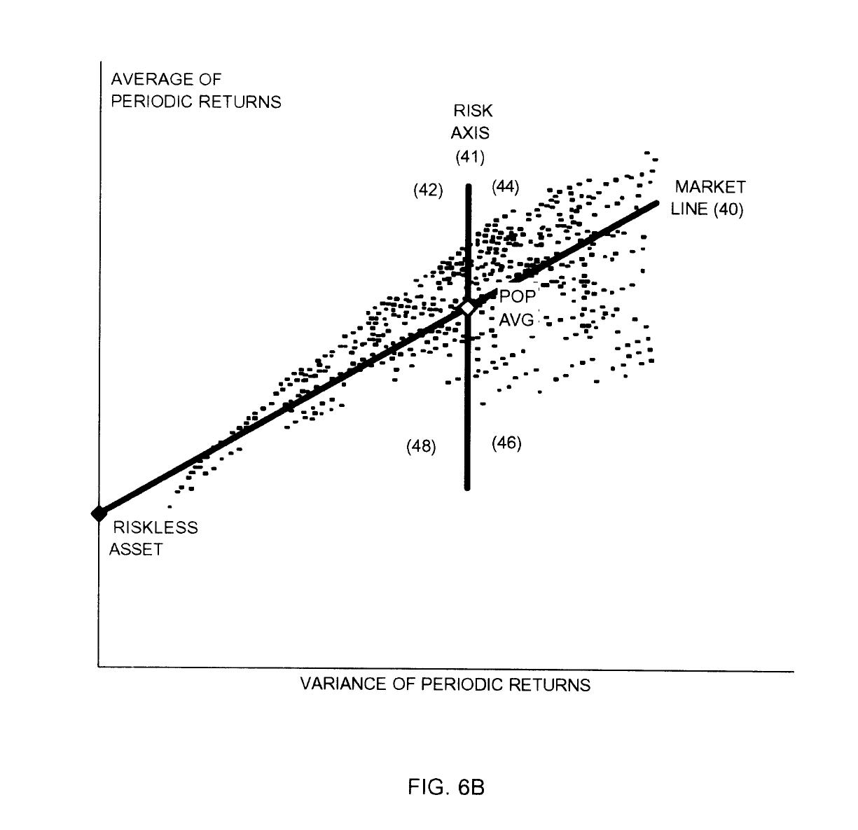

1. The answers to the audit questions listed in Module 30 of FIG. 9 regarding the evaluation of a manager's performance in selecting for market-sector investments will be illustrated on the mean-variance graph of FIG. 5B under the tenets of the Capital Asset Pricing Model. [Sharpe, 1964] A line will be drawn from the point of risk and return for a risk-less asset through a point of average risk and return for the analysis population (“market line”), extending to a point of risk calculated for the riskiest member of the analysis population. A second line will be drawn at the point of risk for the benchmark portfolio made of all selection alternatives in the population (“risk-axis”). The point of risk and return for the investment portfolio function under analysis will also be plotted on this graph in FIG. 5B. These points are also plotted on a graph of average of periodic returns versus the variance of periodic returns in FIG. 6B to answer the audit questions listed in Module 28 of FIG. 9 in regard to the evaluation of a manager's performance in selecting for an asset allocation strategy.

The market line 40 and risk-axis 41 will be used to mark off four areas on the graph. A point of risk and return for a subject manager selection that plots above the market line and to the left of the risk-axis will reside in an area 42 of the graph which can be confirmed statistically to be within a group of managers that consistently perform better than the average of their peers in terms of managing the risks of investment loss and investment uncertainty. The better than average performance in regards to loss risk is verified by virtue of the manager's point of performance residing above the market line in the subject analysis period. The better than average performance in terms of uncertainty risk is verified by virtue of the performance of the managers within area 42 consistently residing above the market line in a time period subsequent to an analysis period in which this group is identified for a series of analysis periods since 1960. This consistency is statistically significant at the +90% confidence level. For the managers in area 42 for the investment selection function, the relative strength of their performance for managing investment uncertainty is impervious to future market conditions—they continue to do well whether the future market strengthens or weakens. For those managers in are 42 for the allocation strategy selection, the relative strength of their performance for managing investment uncertainty is negatively correlated with future market conditions they will do better as the future market weakens. Managers whose subject analysis period performance is found to reside within this area are designated as green (hold), signifying the expectation that their selections will remain among the strongest alternatives for managing investment loss and investment uncertainty risk into the near future.

A point of risk and return for a subject manager selection that resides above the market line and to the right of the risk-axis in area 44 will reside in an area which can be verified to be within a group of managers that have performed better than average in terms of investment loss for the subject analysis period, but that are among those managers whom have statistically (confidence level +90%) had to rely on the continuation of strong market conditions to maintain at least an average level performance into the future. In terms of the management of investment uncertainty the selections made by these managers are sensitive to a change in market conditions and because of this are selection choices that need to be justified by the manager's outlook regarding future market conditions. Managers whose subject analysis period performance is found to reside within this area are designated as yellow (caution), signifying that the portfolio holder should request additional information from his manager concerning his expectations for the future.

A point of risk and return for a subject manager selection that resides below the market line and to the left of the risk-axis in area 48 will reside in an area which can be verified to be within a group of managers that have been less effective than their peer in terms of controlling investment loss for the subject analysis period, and that are among those managers who will continue at or slightly below the average performance of their peers unless future market conditions weaken significantly. In terms of the management of investment uncertainty, the selections made by these managers are contrarian in nature and their continuation within the portfolio needs to be justified in terms of the manager's outlook regarding future market conditions. Managers whose subject analysis period performance is found to reside within this area are also designated as yellow (caution), signifying that the portfolio holder should request additional information from his manager concerning his expectations for the future.

Finally, A point of risk and return for a subject manager selection that resides below the market line and to the right of the risk-axis in area 46 will reside in an area which can be verified to be within a group of have been less effective than their peers in terms of controlling investment loss for the subject analysis period, and that are among those managers whose risk performance is most likely to remain below the average performance of their peers unless future market conditions change significantly (+90% confidence level). For the managers in area 46 for the investment selection function, the relative strength of their performance in terms of managing investment uncertainty will be negatively correlated to future market conditions if the future market significantly weakens their selection will fare better than the selections of their peers. For those managers in area 46 for the allocation strategy selection, the relative strength of their performance for managing investment uncertainty is positively correlated with future market conditions for their selections to perform as well as the selections of their peers, the future market must strengthen considerably. Managers whose subject analysis period performance is found to reside within this area are designated as red (divestiture), signifying that their selections are expected to continue to underperform the selections of their peers into the near future unless the manager can present compelling evidence of a significant and complementary change in market conditions.

The logic of the audit will be to illustrate to current state of the portfolio first. The performance in terms of the management of the risk of investment loss and investment uncertainty for the most recent past time period will be evaluated. If the current portfolio performance resides in a green area 42 for all analyzed functions, the manager has positioned his selections well for both contingencies and the holder can move on to other issues. If a selection resides in an area that is in yellow area 44, it has recently performed well relative to its peers, but may encounter difficulties if market conditions change. If the selection resides within either yellow area 48, or red area 46, its performance is currently below the average of its peers and can be expected to continue to below average unless market conditions change, Residence within either of these last three areas means that further analysis is warranted.

As an optional step, usually taken only for the initial audit report, the original allocation strategy and investment selections are evaluated in terms of their investment loss and investment uncertainty risks relative to their peers at time of portfolio initiation. The logic behind this additional analysis is to confirm that the original portfolio setup conformed to both the manager's and holder's expectations of future market conditions. If the portfolio selections all resided within the green area 42 of their respective functional peers at time of portfolio initiation, then the portfolio was set up to be resilient to market change. If the selections resided within the Yellow or Red areas of their respective peer groups, then the manager must have communicated, and the holder accepted, a specific bias regarding the direction of future market conditions.

In the final analysis, the primary contingency to the value of the selection decisions made by the manager resides in the uncertainty of future markets. The investor must be able to find comfort with that manager's view of the future a view that is commonly revealed at time of portfolio initiation, as well as at the periodic times that the manager reports of portfolio performance, including the current period. The logic of the audit process is to document the manager's selection decisions and justifying statements regarding future market expectations from the point of portfolio initiation through the current period and to provide the user with the data with which to form an analysis of the accuracy of that view over time as it is demonstrated by the portfolio's performance over time. Accumulating statistics of the portfolio's performance in terms of investment uncertainty and analyzing that performance over successive time periods will generate a pattern which will ultimately give rise to either investor comfort or discomfort with a manager's competence and his future plans.

2. The point of average performance for a population of asset allocation strategy alternatives can be calculated a number of different ways. It can either be the risk and return of an allocation alternative made from the average allocation percentage for each market-sector within the population of allocation alternatives. For a 5-market-sector allocation strategy, that point is for the allocation alternative 20%-20%-20%-20%-20%; for a 4-market-sector strategy, the point is for the alternative 25%-25%-25%-25%. It can also be the risk and return calculated from the series of periodic returns calculated for a portfolio made from all the allocation alternatives within the population. For populations of allocation strategy alternatives made from book-valued collections of investments, either of these methods for calculating an average has produced essentially the same results for time periods over the last forty years.

Additionally, a user can identify a market benchmark to mark an average by which to draw a market-line. An investor can designate an average maximum and a market-contingent risk for his portfolio using this market benchmark the portfolio risk not to exceed the average risk and pattern of the bond market, as represented by the average risk and return of the Lehman Brothers Aggregate Bond Market Index, for example.

For analyses of market-sector level performance, the preferred point of average risk and return is that calculated for a market-sector index as formulated by the method outlined in the patent application, “Process to Create Market-Sector Investment Portfolio Performance Indices”. For populations of investments within a market-sector, there does exist a sufficient difference in the risk calculated for a portfolio made from those investments versus for a random selection of an investment from that population. That difference in risk is revealed in time periods when the underlying economics affecting the investments of the sector are undergoing change. In the illustrations, this preferred benchmark is titled, “sector-portfolio” or “pop avg”.

3. It has become convention to calculate investment risk at the market-sector level either in terms of an investment alternative's absolute level of returns variance the standard deviation of periodic returns around the return average or in terms of the level of its periodic returns variance relative to the level and pattern of periodic returns variance for a market-sector benchmark. This relative risk measure is known as “beta” and the resultant differential return calculated from this measure as “alpha”. This invention has been tested for and found to general an analysis of identical functionality using either of these two risk measures

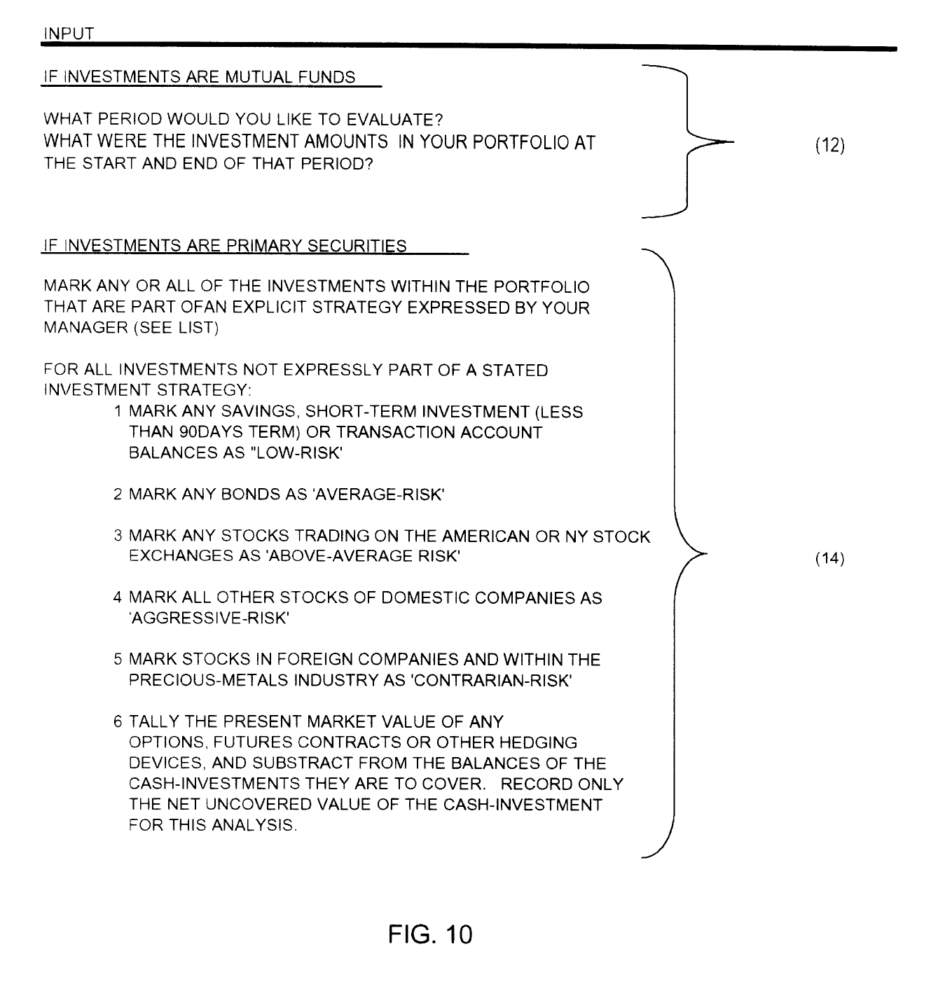

4. The User Input Module 10 creates a record of the composition of a user's investment portfolio. This composition record is inputted by the user and includes the name of each investment and their beginning and ending-period balances. For investments that are not mutual funds, or that were not, when acquired, accompanied by an explicit statement of investment objective by the manager (for example: the stated objective to acquire a portfolio of small-cap growth stocks), the user is also asked to designate a market-sector category. There will be a process built upon the category structure, as shown in FIG. 10, for prompting the user through this designation steps at stages 12 and 14, as follows:

The audit system uses this category information to form a view of the portfolio at different points of aggregation—the levels of investment-objective, market-sector and allocation-strategy peers. The analysis of predictive processes of investment selection is performed at the lowest level of aggregation investment-objective peers. The analysis of diversification processes for investment selection is performed at the market-sector level of aggregation. And the analysis of predictive and diversification processes for allocation-strategy selection is performed against a population of allocation-strategy peers.

4. These aggregation levels, to be utilized within an auditing context, must represent groupings that are consistent with generally-accepted practices of the investment management industry and that are seen within the industry as being germane to the analysis of the functional processes of investment portfolio management.

An audit procedure, to be functional, must measure functions that are generally recognized and accepted as legitimate and germane by practitioners within the industry being audited. For example, an accounting audit that measures whether transactions have been attributed to the proper time period benchmarks a function that is generally recognized as legitimate and germane by investors, lenders and other parties interested in evaluating the functioning of a business entity. The boundaries for determining how to attribute a transaction to a specific time period are laid out in a series of accounting principles. These principles are promulgated by an industry group and approved by the members of the industry, and are therefore represent generally-accepted practices of the accounting industry. The name for these principles—GAAP actually describes this process, “Generally Accepted Accounting Principles”.

Grouping data is a necessary function of an audit when that audit is based on peer benchmarks. The demarcation of a peer group for evaluating investment manager performance needs to be based on grouping schemes that are generally-accepted within the investment industry. There are two of these grouping schemes employed by my process, as they apply to mutual funds one at the broadest end of grouping schemes and one at the narrowest.

It is generally recognized and accepted by investors and other parties with an interest in the performance of an investment portfolio that a primary function of the creation of that portfolio is to create diversity that will limit investment risk. The generally accepted method for creating this diversity is contained in the tenets of Modern Portfolio Theory. [Markowitz, 1956] Those tenets indicate that a population of investments should be grouped into a small number of “market sectors” groups of investments whose past patterns and levels of periodic returns variance have been uniquely similar. This is the broad-grouping scheme employed by this process dividing the sample population of mutual funds into market sectors based on unique commonalities in the past pattern and level of their investment risk.

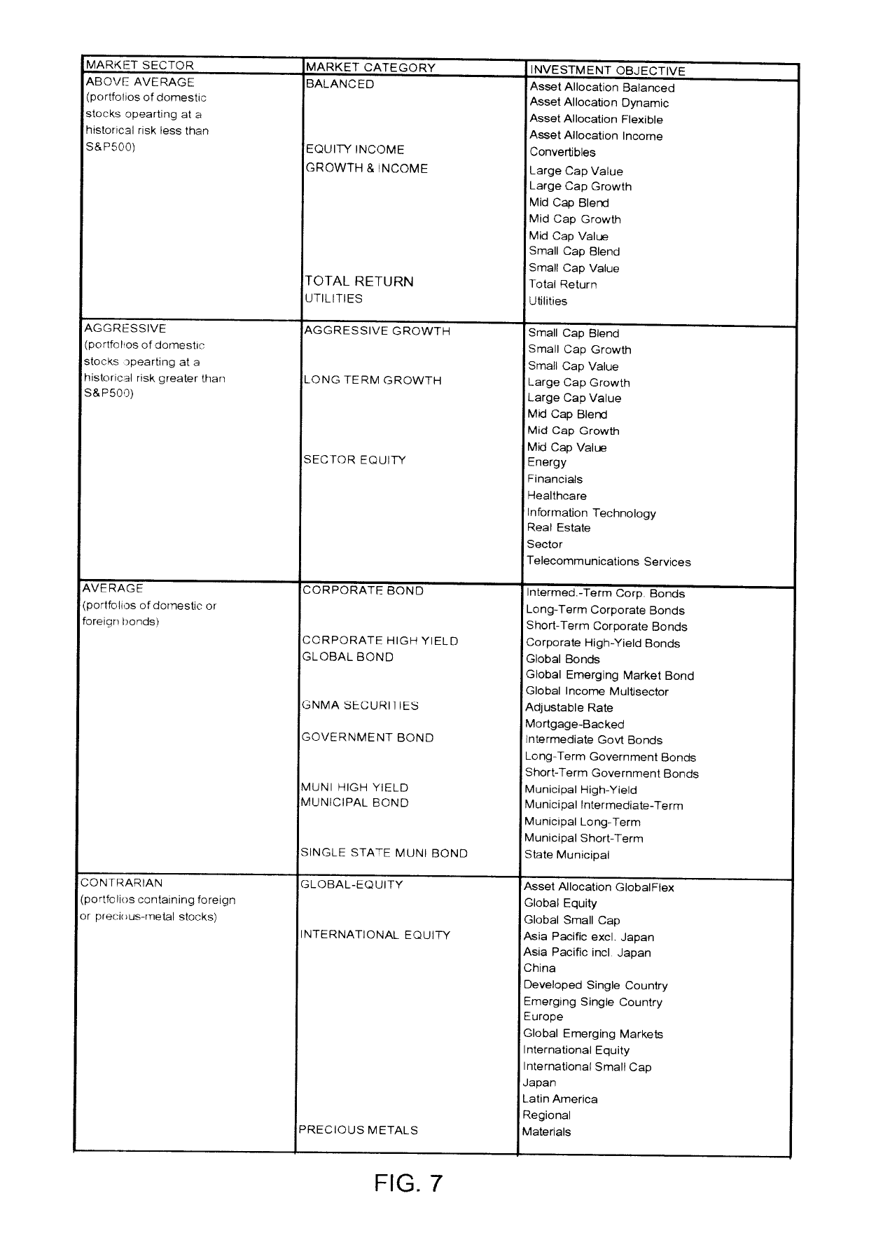

My process currently divides the mutual fund market into five market sectors whose membership and general characteristics are listed below. Details of these sectors are shown in FIG. 7. This listing of characteristics includes an indication of a primary-market with which these market-sectors are associated by virtue of unique commonalities between the past pattern and level of average risk within the market sector and that of an index associated with this primary market.

| | | Population | Associated |
|---|---|---|---|
| Market | Portfolio | December | Primary - |
| Sector | Characteristics | 2001 | Market Index |
| Aggressive | domestic | 4,670 | NASDAQ Market |
| | equities | | |
| Above | domestic | 2,300 | S&P 500 Market |
| Average | equities | | |
| Average | domestic | 4,050 | Lehman Aggregate |
| | bonds | | Bond |
| Low-risk | domestic money | 1,500 | Yield - 90 day |
| | market | | TBill |
| Contrarian | foreign equities | 1,830 | MSCI-EAFE |
| | and bonds | | |
| Total Market | | 14,350 | |

At the narrowest end, mutual funds are required by law to identify an “investment objective” a written description of their markets and investment philosophy. It is to the investment manager's advantage to make these descriptions as broad and vague as possible, and there exist a number of commercial entities whose business entails interpreting and categorizing these descriptions into groups.

The issue for the manager is in making these categories broad enough to be resilient to changes in market conditions. Fund managers promulgate vague descriptions to provide themselves flexibility to follow positive market trends and this has caused complaints about “investment-objective drift” from economists attempting to devise selection and evaluation systems based on narrowly defined peer groups of investments.

Thus said, the User Input Module 10 contains methods for the investor to designate membership into increasingly broader categories of investment objective classifications if the detailed investment objective for an investment is not readily apparent or has not been explicitly defined by the manager as outlined in FIG. 10.

Planned Use for the Invention

The plan for this invention is to offer it through certified public accountants, investment advisors and other providers of auditing services to interested investors. These interested investors run the gamut from those retail investors wondering whether their brother-in-law's advice is reasonable, to institutional investors concerned about their liability as fiduciaries for the prudent management of the investment portfolios containing employee retirement, trust or corporate funds. The unique attribute of this auditing process is its ability to explicitly evaluate the performance of an investment portfolio in terms of the four functional processes of investment portfolio management and specifically, to assess the performance of those processes involving portfolio diversification.

Portfolio diversification is a powerful tool for limiting investment risk and for institutional investors trusts, insurance companies and banks whose businesses rely on the control of investment risk. This audit process will be offered as a structured program for the senior management of these entities to use as a device to communicate policy and evaluate the performance of line managers responsible for investment performance.

Portfolio diversification is a key fiduciary requirement for the administration of qualified employee retirement programs. Companies that sponsor self-directed employee retirement plans (410k plans) are liable for damages arising the provision of a population of investment choices that does not adequately provide the opportunity for those employees to hold a diversified portfolio. This process will generate audit results that are germane to this issue.

Individual investors have been told over the years by investment professionals that they need to be “long-term” investors that they are required to achieve a Zen-like patience that extends over multiple market cycles before forming an opinion regarding the appropriateness of the portfolio-strategy and investment-selection advice they have been provided. Most individual investors cannot afford to take this long-term risk counting on their investment portfolios to fund college, home purchase or retirement commitments.

What these investors need, in terms of the long-term perspective, is portfolio management practices that can be counted upon to have some resilience over the long-term practices that has been demonstrated to provide consistently strong returns across multiple market cycles. This type of portfolio management comes from either extraordinary talent in predicting market trends or a solid program of portfolio diversification. My process will reveal whether either of these characteristics are present within the management of an investor's portfolio, and can explicitly highlight any weaknesses in that management.

Investment portfolios are generally managed through a combination of predictive and diversity processes. A process to audit the performance of an investment portfolio cannot be built upon such a combination of methods. Such an audit process would be, by its nature, subjective and worthless. An auditor of the performance of investment portfolios needs to operate a one of the two extremes of these management processes and establish a system of benchmarks and standards based on the results obtained either diversification or prediction.

There exist a number of commercial ventures built upon benchmarks generated by predictive methodology evaluating the performance of an investment manager against a single investment alternative, commonly the best-performing alternative from among the investment portfolio management choices available in a prior time period or the alternative projected to be the best-performing one in a future period. Examples of the prior art built upon this extreme will be outlined later in the text. There exist no processes based upon benchmarks generated by a diversification methodology evaluating the performance of an investment manager against a portfolio made from the complete range of investment portfolio management choices available in a prior period. This is the unique capability of my process.

The advantage of an audit process built upon the benchmarks of complete portfolio diversification is that it is suitable for measuring the performance of an investment portfolio in regard to both predictive, as well as diversity standards. Audit processes built upon the identification of the single-alternative benchmark focus on measuring portfolio performance in terms of predictive methods and have only limited application in evaluating the strength of the diversification function.

The applicability of auditing processes built on benchmarks of predictive success is further clouded by the inconsistency of those benchmarks over successive phases of a market cycle. Economists have long noted that the fortunes of the best performing investment managers among a market-sector peer group or the strongest asset allocation strategies found on an efficient frontier of a population of allocation choices are an unstable lot prone to become among the worst performing alternatives among their peers as market conditions change. [Goetzmann, 1994], [Elton, 1996], [Cahart, 1997], [Tanous, 1997, p.99]

Because of this, the populations that underlie benchmarks made from the strongest alternatives in a single market period are in constant flux, as these population members disappear with a subsequent market change. Benchmarks crafted from the entire populations of alternatives create an analysis advantage in that their composition, by definition, never changes. An important objective of an audit is to communicate the condition of a process to those that not intimately familiar with that process. It is helpful to those communications to not have “the script” change with every turn of the market.

The argument for consistency over time extends to the choice of investment populations with which to benchmark, as well. Because an audit process must be built upon benchmarks and standards that can generate a consistent measurement of relative performance over time, and because the condition of investment markets tends to change over time, benchmarks and standards to evaluate the performance of an investment portfolio must generate a measurement of relative performance that is adaptive in maintaining its consistent over the phases of market cycles.

Such benchmarks and standards can only be crafted from populations of peers, groupings of investment alternatives whose performance follows a common path in response to market conditions. Investment groupings exist for populations of primary securities stocks and bonds, as well as for populations of other investments, such as mutual funds and annuities. Many of these groupings have been codified as “indices” measurements of investment performance for the group held as a portfolio over multiple time periods.

The issue with building an audit process based on the concept of complete diversification is how to represent that concept of complete diversification in practical terms. Complete diversification means “holding the market”, a conceptual device that is impractical to execute in a $40 trillion global public-securities market given the research and transaction expenses involved in ensuring that one actually held a market-value-weighted share of every securities issue available at each point in time. [Elton, 1995, pp. 97-99]

Economists have long held that a “market portfolio”—the result of holding the market—can be identified by finding the asset allocation strategy alternative that produces the point of maximum efficiency (strongest investment performance) from among a population residing on an efficient frontier. This is another idea that works much better in theory than in practice. In a $40 trillion market, the combination of investments that actually produces this point is impossible to model. Being the product of market-value-weighted returns, it is also a point whose asset composition is in constant flux. The process undertaken to translate the concept into practice is one of selecting for a proxy investment usually an index—to represent the idea of holding the market or a market portfolio.

The generally accepted practice for selecting this proxy follows prevailing economic theory a primary-market index is selected that appears to provide the strongest investment performance for a point in time and the combination of securities within that index is anointed as the “best representative” of truly well diversified portfolio.

The folly of this, of course, is that the fortunes of market-sectors, and their indices, change over time. The benchmark of a market portfolio found as the strongest-performing alternative in one period is often among the weakest-performing of the next. A case in point is the recent popularity of the S&P500 Market Index as the proxy for a market portfolio. This index, although widely promoted as the appropriate benchmark to evaluate investment portfolio performance when it was generating a +28.5% average annual return (1995-99) has fallen into disuse in recent years as its performance has declined to a (−) 15.9% average annual return (2000-YTD0602).

In parallel to the $40 trillion primary-market securities market there exists a $10 trillion mutual funds market. Mutual funds are shares of investment companies business entities made up of investment portfolios managed by investment managers that are valued at the book value of their portfolio holdings. As a population of investment managers, the funds market provides the perfect proxy by which to value the performance of a privately held investment portfolio and by which to construct a market portfolio.

I use the performance of populations of mutual funds as benchmarks for this audit process but this is not the point of novelty. The uniqueness of their use in this process arises from the insight that a market portfolio the act of complete diversification is the summation of a set of portfolio construction choices available to a manager, and that the market portfolio that arises from the summation of these choices is going to be something much different from the one anticipated by economic theories concerning market efficiency.

I have built my audit process upon benchmarks generated from groupings of mutual funds, believing that they are the population of securities whose performance most closely resembles that of a managed investment portfolio. This is not what makes it unique and the choice does not preclude building the process upon benchmarks generated by populations of other securities types. It is the process of generating these benchmarks mechanically as the summation of all available choices for each of the (4) processes, and use of these benchmarks to measure the action of complete diversification, that is its novelty.

These and other modifications and variations occurring to those skilled in the art are intended to fall within the scope of the appended claims.

1. A method of auditing the performance of investment portfolios, comprising the steps of:
providing an allocation alternative database;
providing a market-sector indices database;
providing a mutual fund performance database;
providing a user input of a composition of an investment portfolio;
translating the user input into higher aggregations of portfolio composition and management functions;
analyzing the performance of the investment portfolio for the function of asset allocation strategy selection in terms of the management of both investment loss and investment uncertainty risk;
analyzing the performance of the investment portfolio for the function of market-sector portfolio selection in terms of the management of both investment loss and investment uncertainty risk;
analyzing the performance of the investment portfolio for the function of individual investment selection in terms of investment loss risk;
reporting first results of the performance of the investment portfolio of the relative level of loss risk generated by the selection of individual investments at the market-sector level;
reporting second results of the performance of the investment portfolio of the relative levels of loss and uncertainty risk generated by the selection of investments at the market-sector level;
reporting third results of the performance of the investment portfolio of the relative levels of loss and uncertainty risk generated by the selection of an allocation strategy at the asset allocation level;
generating an audit report from the first, second and third results.

2. The method of claim 2, wherein the step of providing user input further comprising the steps of:
determining whether the type of investment as being a mutual fund, other book-valued investment fund, market-valued investment fund or a primary-market security.

3. The method of claim 3, further comprising the following steps if the investment type is a mutual fund, other book-valued investment fund, market-valued investment fund:
setting a period of evaluation having a start and an end;
determining an investment amount at the start of the period of evaluation;
determining an investment amount at the end of the period of evaluation.

4. The method of claim 3, further comprising the following steps if the investment type is a primary-market security:
providing an initial-period and ending period market value and record of distributions paid for cash-investment securities;
marking any savings, short-term investment, transaction accounts as “low-risk”;
marking bonds as “average risk”;
marking stocks trading on the American Stock Exchange and New York Stock Exchange as “above average risk”;
marking domestic stocks not trading on the American Stock Exchange and New York Stock Exchange as “aggressive risk”;
marking stocks in foreign companies and within the precious metals industry as “contrarian risk”;
tallying the change in the market value of any options, futures contracts and other hedging devices over the analysis period, and netting this change in value against the period gross return from the cash-investment securities for covering therewith;
determining a net return from the cash-investment securities; and
recording net return amount.

5. The method of claim 1, wherein the step of analyzing the performance of the investment portfolio in terms of the selection of an allocation strategy further includes the steps of:
determining the initial asset allocation strategy;
determining the attributes of the strategy in terms of relative levels of investment loss and investment uncertainty risk at the time of initiation of the strategy;
determining the attributes of the initial strategy in terms of relative levels of investment loss and investment uncertainty risk historically;
determining the current allocation strategy;
determining the attributes of the strategy in terms of relative levels of investment loss and investment uncertainty risk for the current analysis period; and
determining the attributes of the current strategy in terms of relative levels of investment loss and investment uncertainty risk historically.

6. The method of claim 1, wherein the step of analyzing the performance of the investment portfolio in terms of the selection of market-sector investments further includes the steps of:
determining the composition of the sector investment portfolio at the beginning date of the analysis period;
determining the current composition of the sector investment portfolio;
determining the periodic returns recorded for each of the investments within the sector portfolio over the analysis period;
determining the attributes of the sector portfolio in terms of relative levels of investment loss and investment uncertainty risk at beginning date of the analysis period; and
determining the attributes of the sector portfolio in terms of relative levels of investment loss and investment uncertainty risk over the span of the analysis period.

7. The method of claim 1, wherein the step of analyzing the performance of the investment portfolio in terms of the selection of individual investments further comprises the steps of:
determining the attributes of the selected investments in terms of their relative level of investment loss risk at time of acquisition; and
determining whether the attributes of the selected investments in terms of their relative level of investment loss risk currently.

8. The method in claim 1, wherein the step of analyzing the attributes of the functions of allocation strategy, market-sector portfolio and individual investment selection in terms of their relative level of investment loss risk comprises the steps of:
determining a peer group for this relative measure that is constructed from a representative population of all the selection alternatives available to the manager for the analysis period;
determining a benchmark measure of average investment performance for that peer group over the analysis period using the tenets of the Capital Assets Pricing Model to construct a market line through a point of average investment return and investment risk for the peer group; and
grading the relative strength of the manager's selection performance by the relationship of the investment performance derived from his selection for the analysis period to this market line.

9. The method in claim 1, wherein the step of analyzing the attributes of the functions of allocation strategy and market-sector portfolio selection in terms of their relative level of investment uncertainty risk comprises the steps of:
determining a peer group for this relative measure that is constructed from a representative population of all the selection alternatives available to the manager for the analysis period;
determining a benchmark measure of investment risk that peer group over the analysis period as the level of risk generated by a portfolio made up of all the selection alternatives available to the manager for the selection function over the analysis period;
designating the portfolio made up of all the selection alternatives available to the manager for the selection function as the population portfolio and the benchmark measure derived from this portfolio as the risk-axis for the peer group; and
grading the relative strength of the manager's selection performance by the relationship of the investment performance derived from his selection for the analysis period to this risk-axis and the peer group market line.

10. The method of claim 8, wherein the peer group used to determine relative performance for the function of asset allocation selection is comprised of the population of asset allocation alternatives that can be constructed from the combination of five market-sector populations in increments of 5-percent each.

11. The method of claim 9, wherein the peer group used to determine relative performance for the function of market-sector portfolio selection is comprised of the population of mutual funds present within each market-sector for the analysis period.

12. The method of claim 9, wherein the point of investment risk marked for the risk-axis is the point of investment risk for the population portfolio for each of the populations of asset allocation strategy alternatives market-sector portfolio alternatives available in the analysis period.

13. The method of claim 10, wherein the market-sector investment performance used to calculate the performance characteristics of the population of asset allocation alternatives is the investment performance of the population portfolio for each market-sector over the analysis periods.

14. The method of claim 9, wherein the grade calculated for the relative strength of the manager's selection performance in terms of his management of investment uncertainty further comprised the steps of:
assigning the manager to one of four groups based on the position of the investment performance of his selections relative to the intersection of the peer group market line and risk-axis;
determining the probable position of the investment performance of his selections relative to the peer-group market line for a time period subsequent to the analysis period based on historical precedent;
communicating the findings of the probable position of the investment performance of his selections relative to the peer-group market line for a time period subsequent to the analysis period in terms of the characteristics of statistical probability and correlation to the relative pattern of investment returns for the peer group in that subsequent period.
